(19) United States
(12) Patent Application Publication
(10) Pub. No.: US 2025/0301364 A1
(43) Pub. Date: Sep. 25, 2025

(54) MEMORY PLATFORM NOISE MITIGATION IN MULTI-LINK OPERATION

(71) Applicant: Intel Corporation, Santa Clara, CA (US)

(72) Inventors: Dong-Ho HAN, Beaverton, OR (US); Joy PODDAR, Bangalore (IN); Ana M. YEPES, Portland, OR (US); Farnaz FOROUGHIAN, Hillsboro, OR (US); Michael SHUSTERMAN, Portland, OR (US); Amit ZEEVI, Ra'anana (IL); Ehud RESHEF, Kiryat Tivon (IL); Amir Ali RADJAI, Portland, OR (US); Christopher P. MOZAK, Portland, OR (US)

(21) Appl. No.: 18/613,193

(22) Filed: Mar. 22, 2024

(51) Int. Cl. H04W 28/02; H04B 17/309; H04W 72/0453; H04W 72/541

(52) U.S. Cl. CPC H04W 28/0236; H04B 17/346; H04W 72/0453; H04W 72/541

(57) ABSTRACT

A device for a computing platform includes a wireless communication device, configured to concurrently receive data from a first wireless link and a second wireless link; and a processor, configured to compute memory platform interference characteristics at the wireless communication device, the memory platform interference characteristics representing a memory noise level experienced in a first wireless frequency channel of the first wireless link and a memory noise level experienced in a second wireless frequency channel of the second wireless link; determine an interference mitigation strategy based on the memory platform interference characteristics, the first wireless frequency channel, the second wireless frequency channel, and one or more candidate memory speeds of the computing platform; and instruct the computing platform or a memory platform to avoid interference based on the interference mitigation strategy.

### TECHNICAL FIELD

Various aspects of this disclosure generally relate to radio signal reception, and in particular to the management of interference generated in a local memory platform.

### BACKGROUND

Until the protocol known as Institute of Electrical and Electronics Engineers (IEEE) 802.11ax (Wi-Fi 6) or, alternatively, Wi-Fi 6 for use in the 6 GHz band (Wi-Fi 6E), client Wi-Fi devices were only permitted to use a single Wi-Fi channel at any given time. This single channel could be, for example, in the 2.4 GHz band, the 5 GHz band, or the 6 GHz tri-band. This is demonstrated in FIG. 1, which shows single-link and multi-link Wi-Fi operations. The single-link limitation of Wi-Fi 6 is depicted as 102.

A key feature of IEEE 802.11be (Wi-Fi 7), however, is Multi-Link Operation (MLO), which enables devices to simultaneously or concurrently send and/or receive data across different Wi-Fi bands or channels, as depicted in 104. In a typical configuration, Wi-Fi modules will continue to use two antennas, thereby resulting in MLO operation configured with two antenna links that may operate on different Wi-Fi channels. For example, each link may be associated with a different channel from any of the tri-band or from the same broad 5 GHz or 6 GHz bands. If two channels are aggregated from the same band, they are generally separated by at least 160 MHz to avoid intra-device transmission (TX)-reception (RX) interference.

In this respect, there are two product-relevant Wi-Fi 7 MLO modes. The first is enhanced multi-link single radio (eMLSR), in which devices may be available on more than one link (e.g., to simultaneously or concurrently listen to multiple links) but can only transmit or receive data through a single link at a given time. Actual concurrency in this mode is limited to receive-receive communications, and therefore channel separations can be very limited. The second mode is simultaneous transmit and receive (STR) multi-link multi-radio (STR-MLMR). Devices supporting this mode can operate their multiple links asynchronously, potentially transmitting on one link while receiving on the other. Most STR devices require the two channels to each be in different sub-bands, which better enables inter-band filters to manage in-device coexistence.

In client platforms, memory devices (e.g. small outline dial inline memory modules (SODIMMs), unbuffered dual inline memory modules (UDIMMs)) are often considered the, or one of the, the most significant aggressors (e.g., interference creators) responsible for diminished Wi-Fi receiver performance. The radiated digital noises from memory devices may cause radio frequency interferences (RFI). Moreover, client PC memory may dynamically switch among different speeds (e.g. typically among four different speeds), which may be referred to as dynamic voltage frequency scaling (DVFS) points. Current and future DVFS points are defined within the Wi-Fi 7 bands-meaning that some memory data transfer frequencies are in the 2.4-7.125 GHz range. Otherwise stated, Wi-Fi user experience (Ux) may suffer from reduced throughput and poor connection issues if memory platform noises are received by Wi-Fi antennas.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts single-link and multi-link Wi-Fi operations;

FIG. 2 depicts various Wi-Fi frequency ranges;

FIG. 3 depicts relationships between client memory speeds (or DVFS points) and the Wi-Fi tri-band frequency ranges;

FIG. 4 depicts a conventional strategy of dynamically changing memory speeds based on a real-time Wi-Fi channel and DVFS point;

FIG. 5 depicts dual channels protection by moving away from the DVFS point P1 to P2;

FIG. 6A depicts Option 2-3, which defines a new DVFS point in the 5330-5490 MHz or the 5835-5945 MHz range, in which Wi-Fi devices are not in operation;

FIG. 6B depicts Option 2-3, defining two DVFS points for both low latency and high bandwidth, and defining a new DVFS point in the 5330-5490 MHz or the 583505945 MHz range, in which Wi-Fi devices are not in operation;

FIG. 7 depicts a Wi-Fi 7 single and multi-link solution for memory interference;

FIG. 8 depicts a DVFS definition where two DVFS points may be the same for both low latency and high bandwidth using different clock frequencies and gear ratios;

FIG. 9 depicts a device for a computing platform; and

FIG. 10 depicts a method.

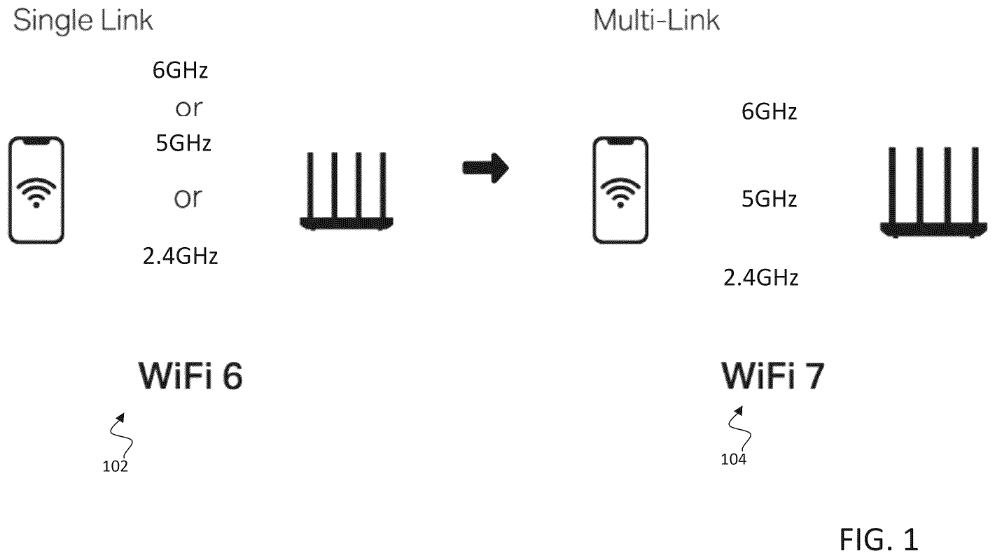

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. As used herein, a memory may refer to any computer-readable storage device that operates according to a clock or pulse. References to “memory” included herein may include double data rate (DDR) memory or low power double data rate memory (LPDDR). Memory may be volatile or non-volatile memory, including random access memory (RAM), read-only memory (ROM), flash memory, solid-state storage, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

The term “frequency channel” is used herein to refer to a predefined frequency or range of frequencies for transmission according to a series of IEEE 802.11, such as, for example frequency channel 40 corresponding to 5200 MHz in a range of 5190-5210 MHz or frequency channel 64 corresponding to 5320 MHz in a range of 5310-5330 MHz. This is in contrast to the use of the term “channel” (e.g. without being preceded by “frequency”), as is commonly used in wireless communication, which may refer to the path between a transmitter and a receiver and/or any corresponding interference, attenuation, etc.

DVFS is a type of power management technique, in which, relative to a memory, a frequency (e.g. a clock frequency) for memory operation can be dynamically set to any of a plurality of speeds (e.g., DVFS points). As stated above, these DVFS points are defined within the Wi-Fi 7 bands such that some memory data transfer frequencies (or harmonics of these memory data transfer frequencies) are within the 2.4-7.125 GHz range, which results in interference for the Wi-Fi receiver. One solution for this problem is to encase the entire memory interconnect (e.g., from the controller to the DRAM devices) with one or more EMI shields. Although this is quite effective, it increases system z-height, bill of materials (BOM) costs, and printed circuit board (PCB) area, as well as diminishes airflow and, at least from the end-user's point of view, impairs DRAM upgradability. Thus, there are multiple reasons why the inclusion of such an EMI shield may be undesirable.

Another known solution is to dynamically adjust DVFS points before the client Wi-Fi scanning takes place or based on an active Wi-Fi channel information. Using these methods, it may be possible to prevent the memory from negatively affecting reception on a given single channel; however, this strategy no longer works for dual channel MLO when the channels are impacted by two different DVFS points.

Of note, and in the descriptions of the proffered solutions as follows, the 2.4 GHz Wi-Fi band can be largely ignored, as the standard low DVFS point (e.g. P0) is already set higher than the frequencies of the 2.4 GHz band. At the same time, double data rate (DDR) or low-power double data rate (LPDDR) memory speeds are increasing, and the high DVFS point for such memory is expected to soon exceed the 7.125 GHz range, thereby also taking the high DVFS point (e.g. P3) outside of the Wi-Fi spectrum. In light of this, it is desired to arrive at one or more judicious DVFS middle points (e.g. P1 and/or P2), using interference avoidance protocols for MLO.

For this, various scenarios are possible, and each scenario may require a different approach. In a first scenario, only one DVFS point is defined in the Wi-Fi band from 5.14 GHz-7.125 GHz. Having only one DVFS point in this range, any combination of dual channels can be protected by dynamically changing memory speeds to move the DVFS point away from the Wi-Fi channel.

In a second scenario, there are two DVFS middle points in the defined Wi-Fi bands (e.g. 5.14 GHz to 7.125 GHz). In this situation, the MLO solution may be any one of the following:

In Scenario 2-1 (e.g. scenario two, option 1), a processor implementing a platform software (SW) or a Wi-Fi firmware (FW) may detect MLO activations and request the power unit (Punit) to skip the two middle DVFS points (e.g. P1 and P2). This leaves only the two DVFS end-points, which may be less desirable options for power and performance (PnP) management, and the use of the two end points would successfully protect Wi-Fi 7 MLO dual channels.

In Scenario 2-2 (e.g. scenario two, option 2), a processor implementing a platform SW or a Wi-Fi FW that can detect MLO activations, and one of two branch executions can be implemented. In a first branch execution (Scenario 2-2-1), the SW/FW may negotiate multi-link channel selections with an AP to avoid dual interferences from two DVFS points. In other words, once the first channel is associated and authenticated, the Wi-Fi driver may block the second channel that has another RFI. The SW/FW algorithm includes the characterization of a platform memory noise to store a mapping table: the interference power level (dBm) vs. the Wi-Fi channel number. The SW/FW also informs a Wi-Fi driver to screen out dual interference channel selections. This option may be unavailable in Wi-Fi 7; however, this option is expected to be feasible in Wi-Fi 8 where the client device is able to negotiate channel selections with APs. In the second branch execution (Scenario 2-2-2), the SW/FW may compute the signal to noise ratio (SNR) from both channels and prioritize the protection of one channel over the other. The SNR_CH1,2 (dB) of each channel may be computed by RSSI_CH1,2 (dB)-Desense_CH1,2 (dB). The SW or FW may prioritize the protection of a lower SNR channel over the other channel of higher SNR. The RSSI is received signal strength indicator that can be obtained from a Wi-Fi driver, and Desense is a different form of the interference power level data.

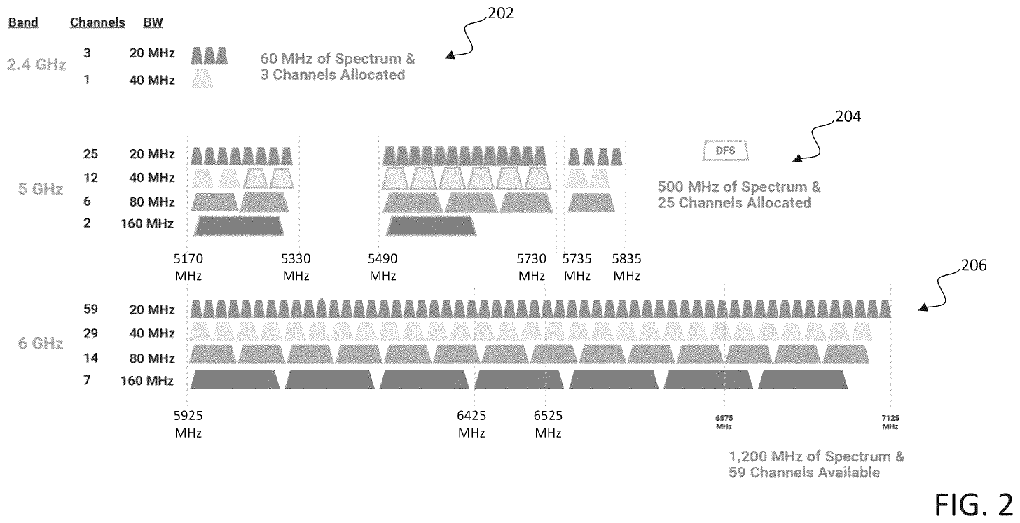

In Scenario 2-3, the processor may enable/define one DVFS point within a frequency range in which Wi-Fi devices are not in operation. For clarity, FIG. 2 depicts the Wi-Fi frequency ranges. As can be seen, and as referenced above, Wi-Fi includes a 2.4 GHz band comprising 4 channels 202, a 5 GHz band comprising 45 channels 204, and a 6 GHz band comprising 109 channels 206. Of note, the 5 GHz band includes a gap from 5.330 GHz to 5.490 GHz, which is reserved for non-Wi-Fi purposes. Furthermore, there is a 110 MHz gap between the 5 GHz band (5.490 GHz to 5.835 GHz) and the 6 GHz band (5.945 GHz to 7.125 GHz). Thus, there are two specific frequency zones that will not be utilized by the Wi-Fi communication, which may be described herein as Zone 1 (5330-5490 MHz) and Zone 2 (5835-5925 MHz). It should be noted that Zone 2 may optionally be expanded to 5815-5945 MHz, given that the 5925-5945 MHz channel is an “orphan” 20 MHz channel.

Memory clocking architectures may define a few legitimate memory speeds based on the clock granularity and PnP optimized gear ratios. As an example, within Zone 1, the memory speed may operate at 5467 MT/s, and within Zone 2, the memory speed may operate at 5867 MT/s. When one DVFS point is defined within zone 1 or zone 2, this renders the situation described herein as Scenario 2 identical to the situation described as Scenario 1. Any dual channel combinations can be protected by simply adjusting the memory speed such that the resulting interference moves away from a noisy DVFS point.

In implementing the solution as disclosed herein, it may be possible to reduce or eliminate memory interference on Wi-Fi communication without changes to the physical design of the device, such as changes that may otherwise affect system z-height or chassis ID. Furthermore, the solution disclosed herein adds no addition bill of materials costs and improves throughput and latency and reliability in Wi-Fi 7, since both MLO channels are protected.

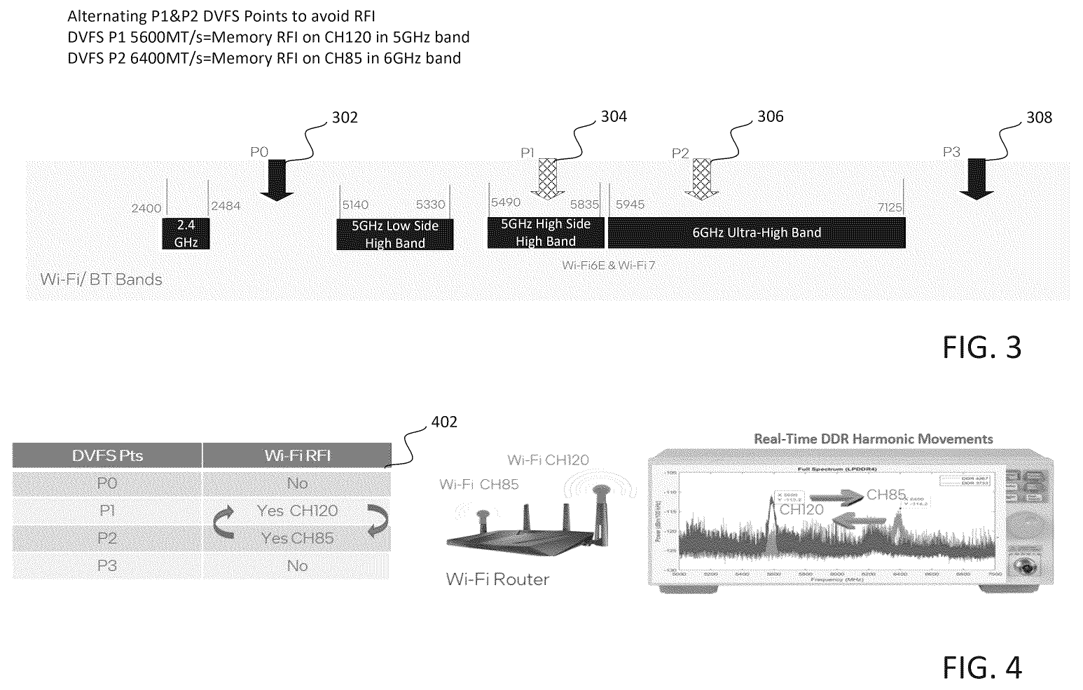

FIG. 3 depicts the relationship between client memory speeds (or DVFS points) and the Wi-Fi tri-band frequency ranges. Widely distributed 4 DVFS points (P0-P3) are generally preferred, or even necessary, for balanced PnP. In this figure, the DVFS points P0, P1, P2, and P3 are depicted as 302, 304, 306, and 308, respectively. The high point, P3 308, is set for (e.g. corresponds to) the maximum CPU/memory performance, and the low point P0 302 is chosen for maximum battery life. As can be seen, the low point, P0 302, can be easily set not to interfere with Wi-Fi band because of the 2656 MHz wide frequency gap (e.g. the gap between the upper frequency of the 2.4 GHz band (2.484 GHz) and the lower frequency of the 5 GHz low-side band (5.140 GHz)). Moreover, as stated above, DDR5 and LPDDR5 DRAM data rates are advancing such that the high point of many such products is, or will soon be, located outside of the Wi-Fi band, thereby simplifying the selection of a P3 point that does not interfere with Wi-Fi reception.

A middle point (e.g. a third DVFS point, a DVFS point between the high DVFS point and the low DVFS point) was introduced for the purpose of PnP balancing; however, because of the 2 GHz wide frequency range between 5.14 GHz and 7.125 GHz, the middle DVFS point is often defined in the Wi-Fi band, which in turn causes RFI issues. The 4th DVFS point was then introduced to mitigate this Wi-Fi RFI issue (e.g. such as in, but not necessarily limited to, Wi-Fi 6/6E) by dynamically relocating the RFI DVFS point to an alternative DVFS point with reduced/minimum PnP impacts caused by the middle DVFS point.

FIG. 4 depicts a conventional strategy of dynamically changing memory speeds based on a real-time Wi-Fi channel and DVFS point data. When a client PC and a Wi-Fi AP finalize the use of channel 120, a processor utilizes, for example, a platform SW or a Wi-Fi FW to check its interference status by reading a current memory DVFS point. If it confirms RFI from the memory, then the device requests the CPU Punit to avoid P1. Similarly, if channel 85 is associated, then the platform SW or Wi-Fi FW sends a DVFS P2 avoidance request. As can be seen from FIG. 4, this solution works well, provided that Wi-Fi is only using a single channel; however, this solution does not work in Wi-Fi 7 MLO, when the device is using dual channels. That is, using this strategy, one of the dual channels will always have RFI if the MLO aggregates channel 85 and channel 120. These two channels are only sampled from the 20 MHz wide channels, but the other 40/80/160/320 MHz channels would have the same issues resulting in substantial negative impacts on MLO. Here it is worth noting that a value of Wi-Fi 7 MLO is flexible aggregation of various wide channels (80 MHz+80 MHz, 80 MHz+160 MHz and 160 MHz+160 MHz), which would be jeopardized in the presence of multiple RFIs caused by memory DVFS points. In light of this, it is necessary to carefully plan DVFS points (e.g. especially middle DVFS points P1 and P2) for Wi-Fi integrations with PnP. That is, with advancing DRAM speeds, if only one DVFS point can be defined in Wi-Fi the band of 5.14 GHZ-7.125 GHz, the MLO would have no dual RFI. This is referred to herein as Scenario 1.

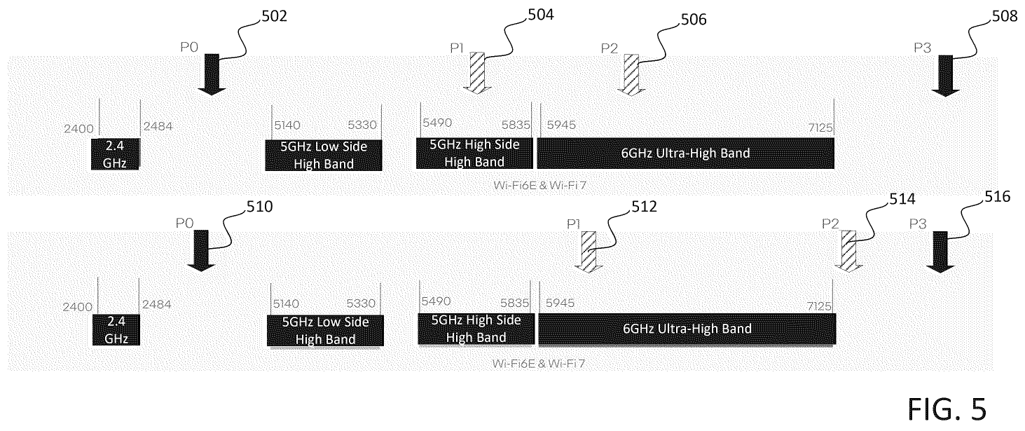

FIG. 5 depicts a scenario in which, having only 1 DVFS point or RFI, any combination of dual channels can be automatically protected by simply moving away from the DVFS point P1 to P2. That is, P0, P1, P2, and P3, which are depicted as 502, 504, 506, and 508, respectively, are arranged as 510, 512, 514, and 516, respectively, such that only one band is affected by the DVFS interference (in this case, as depicted by 512). However, this option might not always be possible (e.g. such as in the multi-channel context with 2-DIMMs per channel). Therefore, it is desired to seek additional solutions.

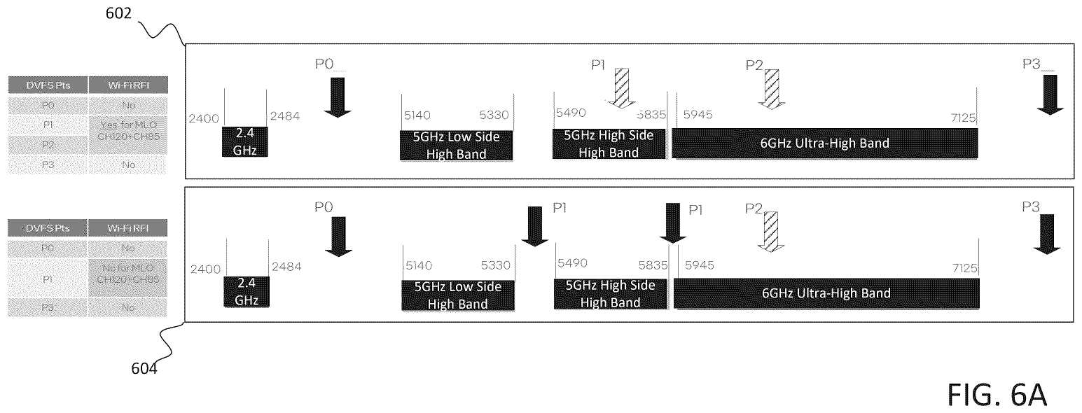

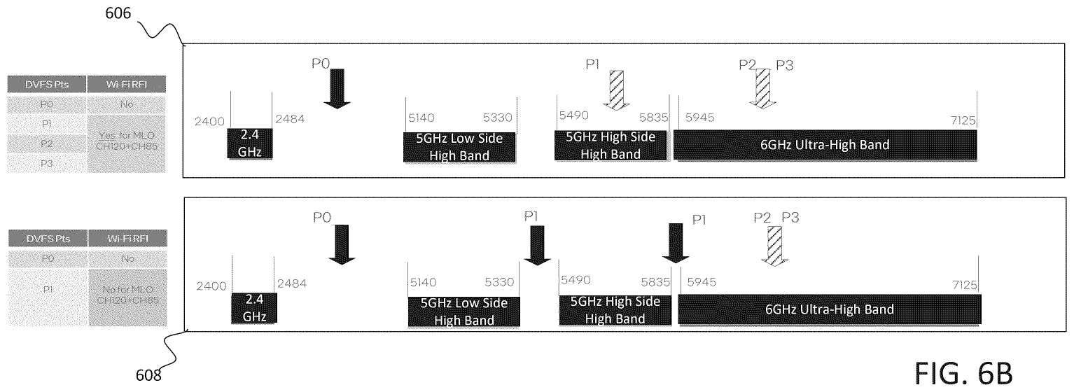

FIG. 6A illustrates two solutions 602 and 604 for an MLO case with a dual RFI issues. For clarity, the DVFS points that cause RFI are depicted as patterned arrows, while the DVFS points that cause no RFI are depicted as solid arrows.

When Wi-Fi MLO activation is detected or dual channel associations happen, a processor, such as a processor implementing a platform SW, can request Punit to block the use of the two middle DVFS points. In this case, only the solid two end DVFS points would be in operation. Accordingly, the MLO dual channels could avoid RFI. This is referred to herein as Scenario 2-1.

Alternatively or additionally, Scenario 2-2 can be implemented inside the Wi-Fi driver to block problematic dual channel combinations. Using the same example, if one of the link channels happened to be 85 (120), then the Wi-Fi driver could reject the secondary channel 120 (85) association. The limitation of this idea, however, is that the available W-Fi channels are mainly decided by the Wi-Fi access point (AP) and client devices may not be permitted to negotiate channel selection with AP. This is expected to change, however, in Wi-Fi 8, which permits the client device to influence AP Wi-Fi channel selection.

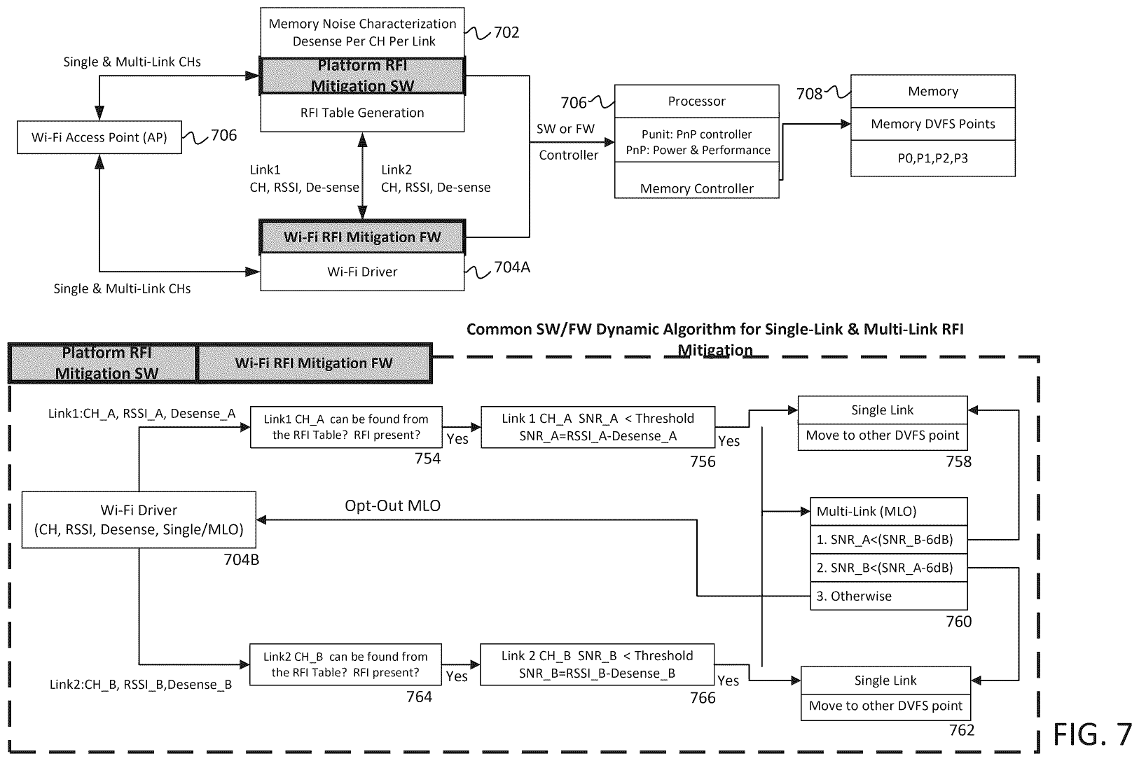

In the meantime, such as during the Wi-Fi 7 era, a processor implementing a platform SW or Wi-Fi FW may prioritize one channel protection over another based on the signal to noise ratio (SNR) comparisons. The SNR_CH A,B (dB) of each channel can be computed by RSSI_CH A,B (dB)-Desense_CH A,B (dB). The received signal strength indicator (RSSI) information is already available from Wi-Fi devices or from the operating system (OS), while the de-sense value of each Wi-Fi channel can be obtained from a platform memory noise characterization. When SNR values are computed, the protection of a lower SNR channel is prioritized over the other channel of higher SNR as will be described in greater detail relative to FIG. 7. As dual link antenna locations are not in perfect symmetry with respect to memory DRAM devices, such a prioritization can be done.

Alternatively or additionally, FIG. 6A 602 and 604 depict Option 2-3, which defines a new DVFS point in the 5330-5490 MHz or the 5835-5945 MHz range, in which Wi-Fi devices are not in operation. That is 602 depicts the problem scenario in which P1 and P2 both generate interference in the Wi-Fi channels, but wherein, as depicted in 604, one of P1 or P2 is moved to Zone 1 or Zone 2, such that the corresponding DVFS point does not interfere with the Wi-Fi reception. In fact, in real products, the use of channel 165 (5815-5835 MHz) is highly discouraged because there are no overlapping 40/80/160 MHz channels or no channel aggregation availability. Therefore, if needed, a new DVFS point could be defined even in the 5815-5945 MHz range. Memory clocking has a limited phase lock loop (PLL) granularity and allows only a specific PLL gear ratio ×2 and ×4 for PnP, and therefore there is a limited set of options available for memory clocking speeds. As it happens, however, both 5467 MT/s and 5867 MT/s are possible definitions for a DVFS setting. For completeness, it is noted that FIG. 2 depicts an additional no-radio-zone in the range of 5730-5735 MHz compared to the no-radio-zones depicted in FIG. 6A, but this is functionally too small a frequency range to accommodate memory clocking PLL restrictions for PnP and a 0.5% spread memory noise of 30 MHz.

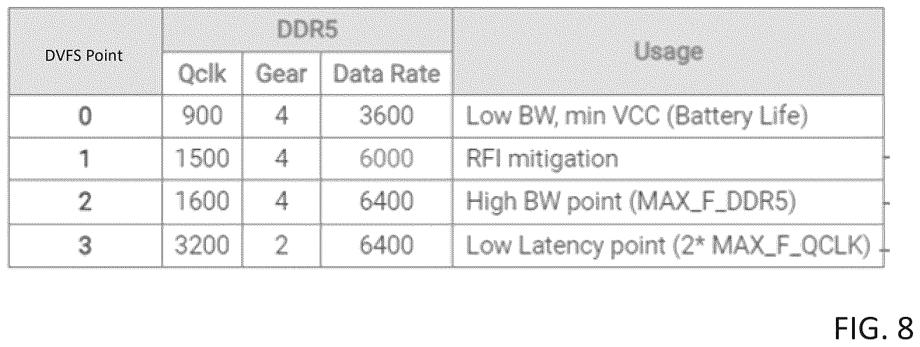

For the sake of being comprehensive, however, FIG. 6B is provided to address multi-channel configurations and configurations with 2-DIMMs per channel. That is, 606 depicts a configuration in which DVFS points P2 and P2 and/or P3 interfere in the Wi-Fi spectrum. 608 depicts a solution to this situation. In greater detail, in such cases as depicted in 606, the high point (P2 and/or P3) does not exceed 7.125 GHz and is therefore still defined within the Wi-Fi band. As can be seen in 606, there are three DVFS points in the Wi-Fi band (e.g., P1, P2, and P3), but two of these points (P2, and P3) are identical in frequency: the differences are in high bandwidth and low latency PLL clock configurations as will be shown in detail in FIG. 8. From a Wi-Fi interference perspective, this MLO solution would be the same as in Scenario 2-3, above. FIG. 6B 608 illustrates that MLO solutions would enable a DVFS point either in Zone 1 or Zone 2 of no-radio zones.

FIG. 7 depicts a Wi-Fi 7 single and multi-channel solution for memory interference. In this figure, a processor performs a dynamic algorithm. The same algorithm can be run either by a platform SW (see Platform RFI Mitigation SW) 702 or Wi-Fi FW (see Wi-Fi RFI Mitigation FW) 704A. The platform SW 702 may be used to generate or update an RFI table that is a form of mapping table between the Wi-Fi channel number and the DeSense value per link. The Platform SW 702 or Wi-Fi FW 704A may send a signal representing any of its determinations to any of a processor (e.g. a system processor, an application processor, the CPU), the Punit, or a memory controller 706, which may send a signal to control a DVFS point of the memory to the memory 708.

The algorithm may have access to channel information, such as from the Wi-Fi access point 704A or the operating system (OS) driver, and DVFS information, such as from a corresponding system on chip (SOC) or Punit. Using some or all of the above, the platform RFI mitigation SW 702 or the Wi-Fi RFI mitigation firmware 704A may determine whether the Link1 channel (CH-A) can be found from the RFI table and whether RFI is present 754. If the determination is in the affirmative, then the platform RFI mitigation SW 702 or the Wi-Fi RFI mitigation firmware 704A may determine whether the Link1 channel's (CH_A) SNR is less than a predetermined threshold 756. If this determination is also in the affirmative, then the platform RFI mitigation SW 702 or the Wi-Fi RFI mitigation firmware 704A may move to another DVFS point 756 if operating in single link mode. Similarly, the platform RFI mitigation SW 702 or the Wi-Fi RFI mitigation firmware 704A may determine whether the Link2 channel (CH-B) can be found from the RFI table and whether RFI is present 764. If the determination is in the affirmative, then the platform RFI mitigation SW 702 or the Wi-Fi RFI mitigation firmware 704A may determine whether the Link2 channel's (CH_B) SNR is less than a predetermined threshold 766. If this determination is also in the affirmative, then the platform RFI mitigation SW 702 or the Wi-Fi RFI mitigation firmware 704A may move to another DVFS point 762 if operating in single link mode. In operating in the multi-link mode (MLO), then the platform RFI mitigation SW 702 or the Wi-Fi RFI mitigation firmware 704A may determine whether the SNR of channel A is less than the SNR of channel B minus a predetermined threshold (e.g., 6 dB), and whether the SNR of channel B is less than the SNR of channel A minus the predetermined threshold (e.g., 6 dB). If the SNR of channel A is less than the SNR of channel B minus 6 dB, then the DVFS will be selected to protect (e.g. reduce noise on) channel A. If the SNR of channel B is less than the SNR of channel A minus the predetermined threshold (e.g., 6 dB), then the DVFS will be selected to protect channel B. If neither the SNR of channel A is less than the SNR of channel B minus the predetermined threshold (e.g., 6 dB) nor the SNR of channel B is less than the SNR of channel A minus the predetermined threshold (e.g., 6 dB), then the device will opt out of MLO and assume SLO mode.

FIG. 8 depicts a DVFS definition for a sample configuration with 2-DIMMs per channel. In this figure, P0 is set to a low value for improved battery life, and P3 is set to a high performance or maximum speed. P2 is set to the same value as P3, and P1 is set to a value for RFI mitigation.

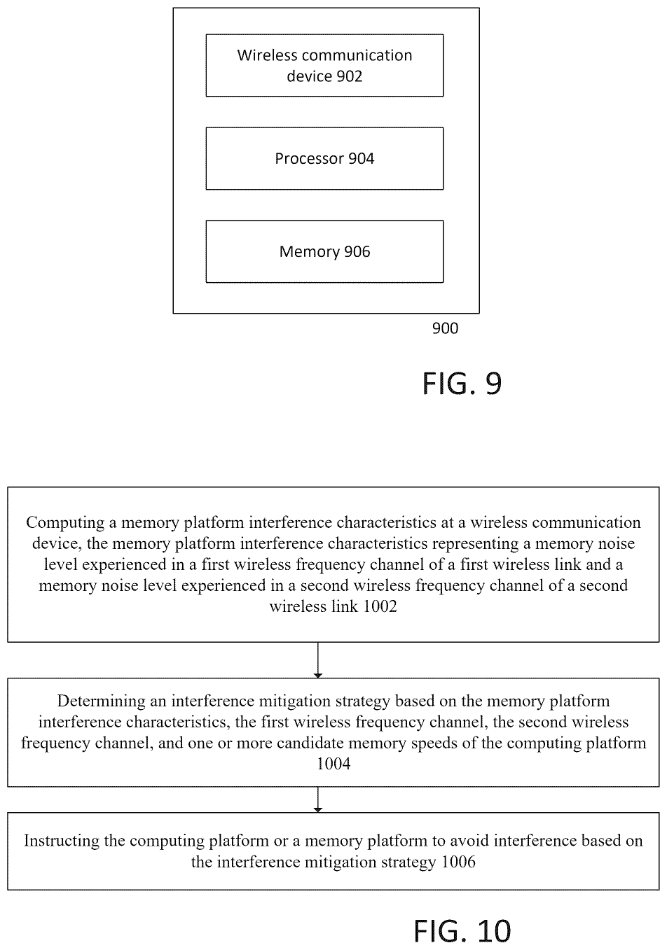

FIG. 9 depicts a device 900 for a computing platform. The device 900 may include a wireless communication device 902. The wireless communication device 902 may be or include any of a baseband modem or a receiver. The wireless communication device 902 may be configured to concurrently receive data from a first wireless link and a second wireless link. The device 902 may include a processor 904, which may be configured to compute memory platform interference characteristics at the wireless communication device 902, the memory platform interference characteristics representing a memory noise level experienced in a first wireless frequency channel of the first wireless link and a memory noise level experienced in a second wireless frequency channel of the second wireless link; determine an interference mitigation strategy based on the memory platform interference characteristics, the first wireless frequency channel, the second wireless frequency channel, and one or more candidate memory speeds of the computing platform; and instruct the computing platform or a memory platform to avoid interference based on the interference mitigation strategy. The memory platform interference characteristics may optionally include an operation of a memory 906 of the computing platform that induces the memory platform interference characteristics the first wireless link and the second wireless link. The memory platform interference characteristics may optionally include a memory operation at a speed, a clock frequency, or a harmonic of the speed or the clock frequency that interferes with a frequency of a 2.4 GHz wireless band, a frequency of a 5 GHz wireless band, or a frequency of a 6 GHz wireless band; and wherein the 2.4 GHz wireless band, the 5 GHz wireless band, and the 6 GHz wireless band are wireless bands according to a series of the Institute of Electrical and Electronics Engineers Standard 802.11.

The device 900 may optionally include the memory 906. The memory 906 may include or be a double data rate (DDR) memory or a low power double data rate memory (LPDDR). The memory platform interference characteristics may comprise an interference signal in the first wireless link or the wireless second link. An operating frequency band of the first wireless link or the second wireless link may optionally be defined by a series of Institute of Electrical and Electronics Engineers Standard 802.11. The first wireless link and the second wireless link may be Multi-link Operation (MLO) links, and as MLO links, they may be optionally defined by a series of the Institute of Electrical and Electronics Engineers Standard 802.11.

The interference mitigation strategy may include changing one or more dynamic voltage frequency scaling settings of the memory. The interference mitigation strategy comprises moving a frequency of a memory platform interference characteristic of the memory platform interference characteristics from a frequency that generates interference inside a band of the first wireless link or the second wireless link to a frequency that generates no interference inside the band of the first wireless link or the second wireless link. The interference mitigation strategy may optionally include disabling one or more dynamic voltage scaling points. The interference mitigation strategy may optionally include changing a first dynamic voltage frequency scaling setting to generate an interference signal in a frequency between 5350-5460 MHz.

The wireless communication device 902 may be optionally configured to receive in any of a 2.4 GHz band, a 5 GHz band, or a 6 GHz band; and wherein the 5 GHz band is further divided into an upper 5 GHz band in a frequency range greater than 5460 MHz and a lower 5 GHz band in a frequency range lower than 5350 MHz. The interference mitigation strategy may include changing a first dynamic voltage frequency scaling setting of the memory to generate an interference signal in a frequency between a 2 GHz band and the lower 5 GHz band. The interference mitigation strategy may include changing a second dynamic voltage frequency scaling setting of the memory to generate an interference signal in a frequency between the lower 5 GHz band the upper 5 GHz band. In this manner, the lower 5 GHz band may be between 5140 MHz and 5330 MHz, and the upper 5 GHz band may be between 5490 MHz and 5835 MHz; and the 6 GHz band is between 5945 MHz and 7125 MHz. The interference mitigation strategy may include the processor altering memory data rates from a first data rate that causes interference in the first wireless link or the second wireless link to a second data rate causes no interference in the first wireless link or the second wireless link.

The wireless communication device 902 or the processor 904 may be further configured to determine a first signal to noise ratio (SNR) for the first wireless link and a second SNR for the second wireless link; and the processor 904 may be configured to determine a first platform noise level for the first wireless link based on the first SNR and to determine a second platform noise level for the second wireless link based on the second SNR. The processor 904 may be is further configured to cause the wireless communication device to discontinue Multi-Link Operation (MLO) if a similarity of the first SNR and the second SNR is within a predetermined range. The predetermined range may optionally be 6 dB. In this manner, the processor 904 being configured to cause the wireless communication device 902 to discontinue MLO may include the processor 904 causing the wireless communication device to assign a common band to the first wireless link and the second wireless link. The processor 904 being configured to cause the wireless communication device to discontinue MLO may further include the processor 904 causing the wireless communication device to assign a common frequency channel to the first wireless link and the second wireless link.

The wireless communication device 902 or the processor 904 may be further configured to determine a first signal to noise ratio (SNR) of the first wireless link and a second SNR of the second wireless link. In this manner, the processor 904 may be further configured to cause the wireless communication device 902 to perform Multi-Link Operation with reduced SNR link protection prioritization if a similarity of the first SNR and the second SNR is outside of a predetermined range. In some configurations, the predetermined range may be 6 dB.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

FIG. 10 depicts a method comprising: computing a memory platform interference characteristics at a wireless communication device, the memory platform interference characteristics representing a memory noise level experienced in a first wireless frequency channel of a first wireless link and a memory noise level experienced in a second wireless frequency channel of a second wireless link 1002; determining an interference mitigation strategy based on the memory platform interference characteristics, the first wireless frequency channel, the second wireless frequency channel, and one or more candidate memory speeds of the computing platform 1004; and instructing the computing platform or a memory platform to avoid interference based on the interference mitigation strategy 1006. Further aspects of the disclosure will be described by way of example:

In Example 1, a device for a computing platform comprising a wireless communication device, configured to concurrently receive data from a first wireless link and a second wireless link; and a processor, configured to compute memory platform interference characteristics at the wireless communication device, the memory platform interference characteristics representing a memory noise level experienced in a first wireless frequency channel of the first wireless link and a memory noise level experienced in a second wireless frequency channel of the second wireless link; determine an interference mitigation strategy based on the memory platform interference characteristics, the first wireless frequency channel, the second wireless frequency channel, and one or more candidate memory speeds of the computing platform; and instruct the computing platform or a memory platform to avoid interference based on the interference mitigation strategy.

In Example 2, the device of Example 1, wherein the memory platform interference characteristics comprise an operation of a memory of the computing platform that induces the memory platform interference characteristics the first wireless link and the second wireless link.

In Example 3, the device of Example 2, wherein the memory platform interference characteristics comprise a memory operation at a speed, a clock frequency, or a harmonic of the speed or the clock frequency that interferes with a frequency of a 2.4 GHz wireless band, a frequency of a 5 GHz wireless band, or a frequency of a 6 GHz wireless band; and wherein the 2.4 GHz wireless band, the 5 GHz wireless band, and the 6 GHz wireless band are wireless bands according to a series of the Institute of Electrical and Electronics Engineers Standard 802.11.

In Example 4, the device of Example 2 or 3, wherein the memory comprises a double data rate (DDR) memory or a low power double data rate memory (LPDDR).

In Example 5, the device of any one of Examples 2 to 4, wherein the memory platform interference characteristics comprise an interference signal in the first wireless link or the wireless second link.

In Example 6, the device of any one of Examples 1 to 4, wherein an operating frequency band of the first wireless link or the second wireless link is defined by a series of Institute of Electrical and Electronics Engineers Standard 802.11.

In Example 7, the device of any one of Examples 1 to 5, wherein the first wireless link and the second wireless link are Multi-link Operation (MLO) links as defined by a series of the Institute of Electrical and Electronics Engineers Standard 802.11.

In Example 8, the device of any one of Examples 2 to 6, wherein the interference mitigation strategy comprises changing one or more dynamic voltage frequency scaling settings of the memory.

In Example 9, the device of Example 8, wherein the interference mitigation strategy comprises moving a frequency of a memory platform interference characteristic of the memory platform interference characteristics from a frequency that generates interference inside a band of the first wireless link or the second wireless link to a frequency that generates no interference inside the band of the first wireless link or the second wireless link.

In Example 10, the device of Example 8, wherein the interference mitigation strategy comprises disabling one or more dynamic voltage scaling points.

In Example 11, the device of Example 10, wherein the interference mitigation strategy further comprises changing a first dynamic voltage frequency scaling setting to generate an interference signal in a frequency between 5350-5460 MHz.

In Example 12, the device of Example 10 or 11, wherein the wireless communication device is configured to receive in any of a 2.4 GHz band, a 5 GHz band, or a 6 GHz band; and wherein the 5 GHz band is further divided into an upper 5 GHz band in a frequency range greater than 5460 MHz and a lower 5 GHz band in a frequency range lower than 5350 MHz.

In Example 13, the device of Example 12, wherein the interference mitigation strategy further comprises changing a first dynamic voltage frequency scaling setting of the memory to generate an interference signal in a frequency between a 2 GHz band and the lower 5 GHz band.

In Example 14, the device of Example 13, wherein the interference mitigation strategy further comprises changing a second dynamic voltage frequency scaling setting of the memory to generate an interference signal in a frequency between the lower 5 GHz band the upper 5 GHz band.

In Example 15, the device of any one of Examples 12 to 14, wherein the lower 5 GHz band is between 5140 MHz and 5330 MHz; the upper 5 GHz band is between 5490 MHz and 5835 MHz; and the 6 GHz band is between 5945 MHz and 7125 MHz.

In Example 16, the device of any one of Examples 1 to 15, wherein the interference mitigation strategy comprises the processor altering memory data rates from a first data rate that causes interference in the first wireless link or the second wireless link to a second data rate causes no interference in the first wireless link or the second wireless link.

In Example 17, the device of any one of Examples 1 to 16, wherein the wireless communication device or the processor is further configured to determine a first signal to noise ratio (SNR) for the first wireless link and a second SNR for the second wireless link; and wherein the processor is configured to determine a first platform noise level for the first wireless link based on the first SNR and to determine a second platform noise level for the second wireless link based on the second SNR.

In Example 18, the device of Example 17, wherein the processor is further configured to cause the wireless communication device to discontinue Multi-Link Operation (MLO) if a similarity of the first SNR and the second SNR is within a predetermined range.

In Example 19, the device of Example 18, wherein the predetermined range is 6 dB.

In Example 20, the device of Example 18 or 19, wherein the processor causing the wireless communication device to discontinue MLO comprises the processor causing the wireless communication device to assign a common band to the first wireless link and the second wireless link.

In Example 21, the device of Example 20, wherein the processor causing the wireless communication device to discontinue MLO further comprises the processor causing the wireless communication device to assign a common frequency channel to the first wireless link and the second wireless link.

In Example 22, the device of any one of Examples 1 to 20, wherein the wireless communication device or the processor is further configured to determine a first signal to noise ratio (SNR) of the first wireless link and a second SNR of the second wireless link; and wherein the processor is further configured to cause the wireless communication device to perform Multi-Link Operation with reduced SNR link protection prioritization if a similarity of the first SNR and the second SNR is outside of a predetermined range.

In Example 23, the device of Example 21, wherein the predetermined range is 6 dB.

In Example 24, a non-transitory computer readable medium, comprising instructions, which, if executed by one or more processors, cause the one or more processors to: compute memory platform interference characteristics at a wireless communication device, the memory platform interference characteristics representing a memory noise level experienced in a first wireless frequency channel of a first wireless link and a memory noise level experienced in a second wireless frequency channel of a second wireless link; determine an interference mitigation strategy based on the memory platform interference characteristics, the first wireless frequency channel, the second wireless frequency channel, and one or more candidate memory speeds of the computing platform; and instruct the computing platform or a memory platform to avoid interference based on the interference mitigation strategy.

In Example 25, the non-transitory computer readable medium of Example 24, wherein the memory platform interference characteristics comprise an operation of a memory of the computing platform that induces the memory platform interference characteristics the first wireless link and the second wireless link.

In Example 26, the non-transitory computer readable medium of Example 25, wherein the memory platform interference characteristics comprise a memory operation at a speed, a clock frequency, or a harmonic of the speed or the clock frequency that interferes with a frequency of a 2.4 GHz wireless band, a frequency of a 5 GHz wireless band, or a frequency of a 6 GHz wireless band; and wherein the 2.4 GHz wireless band, the 5 GHz wireless band, and the 6 GHz wireless band are wireless bands according to a series of the Institute of Electrical and Electronics Engineers Standard 802.11.

In Example 27, the non-transitory computer readable medium of Example 25 or 26, wherein the memory comprises a double data rate (DDR) memory or a low power double data rate memory (LPDDR).

In Example 28, the non-transitory computer readable medium of any one of Examples 25 to 27, wherein the memory platform interference characteristics comprise an interference signal in the first wireless link or the wireless second link.

In Example 29, the non-transitory computer readable medium of any one of Examples 24 to 27, wherein an operating frequency band of the first wireless link or the second wireless link is defined by a series of Institute of Electrical and Electronics Engineers Standard 802.11.

In Example 30, the non-transitory computer readable medium of any one of Examples 1 to 5, wherein the first wireless link and the second wireless link are Multi-link Operation (MLO) links as defined by a series of the Institute of Electrical and Electronics Engineers Standard 802.11.

In Example 31, the non-transitory computer readable medium of any one of Examples 25 to 29, wherein the interference mitigation strategy comprises changing one or more dynamic voltage frequency scaling settings of the memory.

In Example 32, the non-transitory computer readable medium of Example 31, wherein the interference mitigation strategy comprises moving a frequency of a memory platform interference characteristic of the memory platform interference characteristics from a frequency that generates interference inside a band of the first wireless link or the second wireless link to a frequency that generates no interference inside the band of the first wireless link or the second wireless link.

In Example 33, the non-transitory computer readable medium of Example 31, wherein the interference mitigation strategy comprises disabling one or more dynamic voltage scaling points.

In Example 34, the non-transitory computer readable medium of Example 33, wherein the interference mitigation strategy further comprises changing a first dynamic voltage frequency scaling setting to generate an interference signal in a frequency between 5350-5460 MHz.

In Example 35, the non-transitory computer readable medium of Example 33 or 34, wherein the wireless communication device is configured to receive in any of a 2.4 GHz band, a 5 GHz band, or a 6 GHz band; and wherein the 5 GHz band is further divided into an upper 5 GHz band in a frequency range greater than 5460 MHz and a lower 5 GHz band in a frequency range lower than 5350 MHz.

In Example 36, the non-transitory computer readable medium of Example 35, wherein the interference mitigation strategy further comprises changing a first dynamic voltage frequency scaling setting of the memory to generate an interference signal in a frequency between a 2 GHz band and the lower 5 GHz band.

In Example 37, the non-transitory computer readable medium of Example 36, wherein the interference mitigation strategy further comprises changing a second dynamic voltage frequency scaling setting of the memory to generate an interference signal in a frequency between the lower 5 GHz band the upper 5 GHz band.

In Example 38, the non-transitory computer readable medium of any one of Examples 35 to 37, wherein the lower 5 GHz band is between 5140 MHz and 5330 MHz; the upper 5 GHz band is between 5490 MHz and 5835 MHz; and the 6 GHz band is between 5945 MHz and 7125 MHz.

In Example 39, the non-transitory computer readable medium of any one of Examples 24 to 38, wherein the interference mitigation strategy comprises the processor altering memory data rates from a first data rate that causes interference in the first wireless link or the second wireless link to a second data rate causes no interference in the first wireless link or the second wireless link.

In Example 40, the non-transitory computer readable medium of any one of Examples 24 to 39, wherein the instructions are further configured to cause the wireless communication device or the processor to determine a first signal to noise ratio (SNR) for the first wireless link and a second SNR for the second wireless link; and to cause the processor to determine a first platform noise level for the first wireless link based on the first SNR and to determine a second platform noise level for the second wireless link based on the second SNR.

In Example 41, the non-transitory computer readable medium of Example 40, wherein the instructions are further configured to cause the processor to cause the wireless communication device to discontinue Multi-Link Operation (MLO) if a similarity of the first SNR and the second SNR is within a predetermined range.

In Example 42, the non-transitory computer readable medium of Example 41, wherein the predetermined range is 6 dB.

In Example 43, the non-transitory computer readable medium of Example 41 or 42, wherein the instructions being configured to cause the processor to cause the wireless communication device to discontinue MLO comprises the instructions being configured to cause the processor to cause the wireless communication device to assign a common band to the first wireless link and the second wireless link.

In Example 44, the non-transitory computer readable medium of Example 43, wherein the instructions being configured to cause the processor to cause the wireless communication device to discontinue MLO further comprises the instructions being configured to cause the processor to cause the wireless communication device to assign a common frequency channel to the first wireless link and the second wireless link.

In Example 45, the non-transitory computer readable medium of any one of Examples 24 to 43, wherein the instructions are configured to cause the wireless communication device or the processor to determine a first signal to noise ratio (SNR) of the first wireless link and a second SNR of the second wireless link; and wherein the instructions are further configured to cause the processor to cause the wireless communication device to perform Multi-Link Operation with reduced SNR link protection prioritization if a similarity of the first SNR and the second SNR is outside of a predetermined range.

In Example 46, the non-transitory computer readable medium of Example 44, wherein the predetermined range is 6 dB.

In Example 47, a method comprising: computing a memory platform interference characteristics at a wireless communication device, the memory platform interference characteristics representing a memory noise level experienced in a first wireless frequency channel of a first wireless link and a memory noise level experienced in a second wireless frequency channel of a second wireless link; determining an interference mitigation strategy based on the memory platform interference characteristics, the first wireless frequency channel, the second wireless frequency channel, and one or more candidate memory speeds of the computing platform; and instructing the computing platform or a memory platform to avoid interference based on the interference mitigation strategy.

In Example 48, the method of Example 47, wherein the memory platform interference characteristics comprise an operation of a memory of the computing platform that induces the memory platform interference characteristics the first wireless link and the second wireless link.

In Example 49, the method of Example 48, wherein the memory platform interference characteristics comprise a memory operation at a speed, a clock frequency, or a harmonic of the speed or the clock frequency that interferes with a frequency of a 2.4 GHz wireless band, a frequency of a 5 GHz wireless band, or a frequency of a 6 GHz wireless band; and wherein the 2.4 GHz wireless band, the 5 GHz wireless band, and the 6 GHz wireless band are wireless bands according to a series of the Institute of Electrical and Electronics Engineers Standard 802.11.

In Example 50, the method of Example 48 or 49, wherein the memory comprises a double data rate (DDR) memory or a low power double data rate memory (LPDDR).

In Example 51, the method of any one of Examples 48 to 50, wherein the memory platform interference characteristics comprise an interference signal in the first wireless link or the wireless second link.

In Example 52, the method of any one of Examples 47 to 50, wherein an operating frequency band of the first wireless link or the second wireless link is defined by a series of Institute of Electrical and Electronics Engineers Standard 802.11.

In Example 53, the method of any one of Examples 1 to 5, wherein the first wireless link and the second wireless link are Multi-link Operation (MLO) links as defined by a series of the Institute of Electrical and Electronics Engineers Standard 802.11.

In Example 54, the method of any one of Examples 48 to 52, wherein the interference mitigation strategy comprises changing one or more dynamic voltage frequency scaling settings of the memory.

In Example 55, the method of Example 54, wherein the interference mitigation strategy comprises moving a frequency of a memory platform interference characteristic of the memory platform interference characteristics from a frequency that generates interference inside a band of the first wireless link or the second wireless link to a frequency that generates no interference inside the band of the first wireless link or the second wireless link.

In Example 56, the method of Example 54, wherein the interference mitigation strategy comprises disabling one or more dynamic voltage scaling points.

In Example 57, the method of Example 56, wherein the interference mitigation strategy further comprises changing a first dynamic voltage frequency scaling setting to generate an interference signal in a frequency between 5350-5460 MHz.

In Example 58, the method of Example 56 or 57, wherein the wireless communication device is configured to receive in any of a 2.4 GHz band, a 5 GHz band, or a 6 GHz band; and wherein the 5 GHz band is further divided into an upper 5 GHz band in a frequency range greater than 5460 MHz and a lower 5 GHz band in a frequency range lower than 5350 MHz.

In Example 59, the method of Example 58, wherein the interference mitigation strategy further comprises changing a first dynamic voltage frequency scaling setting of the memory to generate an interference signal in a frequency between a 2 GHz band and the lower 5 GHz band.

In Example 60, the method of Example 59, wherein the interference mitigation strategy further comprises changing a second dynamic voltage frequency scaling setting of the memory to generate an interference signal in a frequency between the lower 5 GHz band the upper 5 GHz band.

In Example 61, the method of any one of Examples 58 to 60, wherein the lower 5 GHz band is between 5140 MHz and 5330 MHz; the upper 5 GHz band is between 5490 MHz and 5835 MHz; and the 6 GHz band is between 5945 MHz and 7125 MHz.

In Example 62, the method of any one of Examples 47 to 61, wherein the interference mitigation strategy comprises altering memory data rates from a first data rate that causes interference in the first wireless link or the second wireless link to a second data rate causes no interference in the first wireless link or the second wireless link.

In Example 63, the method of any one of Examples 47 to 62, further comprising determining a first signal to noise ratio (SNR) for the first wireless link and a second SNR for the second wireless link; and determining a first platform noise level for the first wireless link based on the first SNR and to determine a second platform noise level for the second wireless link based on the second SNR.

In Example 64, the method of Example 63, further comprising discontinuing Multi-Link Operation (MLO) if a similarity of the first SNR and the second SNR is within a predetermined range.

In Example 65, the method of Example 64, wherein the predetermined range is 6 dB.

In Example 66, the method of Example 64 or 65, wherein discontinuing MLO comprises assigning a common band to the first wireless link and the second wireless link.

In Example 67, the method of Example 66, wherein discontinuing MLO comprises assigning a common frequency channel to the first wireless link and the second wireless link.

In Example 68, the method of any one of Examples 47 to 66, further comprising determining a first signal to noise ratio (SNR) of the first wireless link and a second SNR of the second wireless link; and performing Multi-Link Operation with reduced SNR link protection prioritization if a similarity of the first SNR and the second SNR is outside of a predetermined range.

In Example 69, the method of Example 67, wherein the predetermined range is 6 dB.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A device for a computing platform comprising:
a wireless communication device, configured to concurrently receive data from a first wireless link and a second wireless link; and
a processor, configured to:
compute memory platform interference characteristics at the wireless communication device, the memory platform interference characteristics representing a memory noise level experienced in a first wireless frequency channel of the first wireless link and a memory noise level experienced in a second wireless frequency channel of the second wireless link;
determine an interference mitigation strategy based on the memory platform interference characteristics and one or more candidate memory speeds of the computing platform; and
instruct the computing platform or a memory platform to avoid interference based on the interference mitigation strategy.

2. The device of claim 1, wherein the memory platform interference characteristics comprise an operation of a memory of the computing platform that induces the memory platform interference characteristics the first wireless link and the second wireless link.

3. The device of claim 2, wherein the memory platform interference characteristics comprise a memory operation at a speed, a clock frequency, or a harmonic of the speed or the clock frequency that interferes with a frequency of a 2.4 GHz wireless band, a frequency of a 5 GHz wireless band, or a frequency of a 6 GHz wireless band; and wherein the 2.4 GHz wireless band, the 5 GHz wireless band, and the 6 GHz wireless band are wireless bands according to a series of the Institute of Electrical and Electronics Engineers Standard 802.11.

4. The device of claim 2, wherein the memory comprises a double data rate (DDR) memory or a low power double data rate memory (LPDDR).

5. The device of claim 2, wherein the memory platform interference characteristics comprise an interference signal in the first wireless link or the second wireless link.

6. The device of claim 1, wherein the first wireless link and the second wireless link are Multi-link Operation (MLO) links as defined by a series of the Institute of Electrical and Electronics Engineers Standard 802.11.

7. The device of claim 2, wherein the interference mitigation strategy comprises changing one or more dynamic voltage frequency scaling settings of the memory.

8. The device of claim 7, wherein the interference mitigation strategy comprises moving a frequency of a memory platform interference characteristic of the memory platform interference characteristics from a frequency that generates interference inside a band of the first wireless link or the second wireless link to a frequency that generates no interference inside the band of the first wireless link or the second wireless link.

9. The device of claim 7, wherein the interference mitigation strategy comprises skipping one or more dynamic voltage scaling points.

10. The device of claim 9, wherein the interference mitigation strategy further comprises changing a first dynamic voltage frequency scaling setting to generate an interference signal in a frequency between 5350-5460 MHz.

11. The device of claim 9, wherein the wireless communication device is configured to receive in any of a 2.4 GHz band, a 5 GHz band, or a 6 GHz band; and wherein the 5 GHz band is further divided into an upper 5 GHz band in a frequency range greater than 5460 MHz and a lower 5 GHz band in a frequency range lower than 5350 MHz.

12. The device of claim 11, wherein the interference mitigation strategy further comprises changing a first dynamic voltage frequency scaling setting of the memory to generate an interference signal in a frequency between a 2 GHz band and the lower 5 GHz band.

13. The device of claim 12, wherein the interference mitigation strategy further comprises changing a second dynamic voltage frequency scaling setting of the memory to generate an interference signal in a frequency between the lower 5 GHz band the upper 5 GHz band.

14. The device of claim 1, wherein the interference mitigation strategy comprises the processor altering memory data rates from a first data rate that causes interference in the first wireless link or the second wireless link to a second data rate causes no interference in the first wireless link or the second wireless link.

15. The device of claim 1, wherein the wireless communication device or the processor is further configured to determine a first signal to noise ratio (SNR) for the first wireless link and a second SNR for the second wireless link; and wherein the processor is configured to determine a first platform noise level for the first wireless link based on the first SNR and to determine a second platform noise level for the second wireless link based on the second SNR.

16. The device of claim 15, wherein the processor is further configured to cause the wireless communication device to discontinue Multi-Link Operation (MLO) if a similarity of the first SNR and the second SNR is within a predetermined range.

17. The device of claim 15, wherein the processor causing the wireless communication device to discontinue MLO comprises the processor causing the wireless communication device to assign a common band to the first wireless link and the second wireless link or to assign a common frequency channel to the first wireless link and the second wireless link.

18. The device of claim 1, wherein the wireless communication device or the processor is further configured to determine a first signal to noise ratio (SNR) of the first wireless link and a second SNR of the second wireless link; and wherein the processor is further configured to cause the wireless communication device to perform Multi-Link Operation with reduced SNR link protection prioritization if a similarity of the first SNR and the second SNR is outside of a predetermined range.

19. A non-transitory computer readable medium, comprising instructions, which, if executed by one or more processors, cause the one or more processors to:
compute memory platform interference characteristics at a wireless communication device, the memory platform interference characteristics representing a memory noise level experienced in a first wireless frequency channel of a first wireless link and a memory noise level experienced in a second wireless frequency channel of a second wireless link;
determine an interference mitigation strategy based on the memory platform interference characteristics, and one or more candidate memory speeds of the computing platform; and
instruct the computing platform or a memory platform to avoid interference based on the interference mitigation strategy.

20. The non-transitory computer readable medium of claim 19, wherein the memory platform interference characteristics comprise an operation of a memory of the computing platform that induces the memory platform interference characteristics the first wireless link and the second wireless link.
